(19) United States
(12) Patent Application Publication
(10) Pub. No.: US 2023/0386741 A1
(43) Pub. Date: Nov. 30, 2023

(54) NdFeB rare earth magnet and manufacturing method thereof

(71) Applicant: Yantai Dongxing Magnetic Materials Inc., Yantai (CN)

(72) Inventors: Chuanshen WANG, Yantai (CN); Zhongjie PENG, Yantai (CN); Kunkun YANG, Yantai (CN); Zhanji DONG, Yantai (CN); Kaihong DING, Yantai (CN)

(21) Appl. No.: 18/201,196

(22) Filed: May 24, 2023

(30) Foreign Application Priority Data
May 31, 2022 (CN) 202210609436.5

(51) Int. Cl. H01F 41/02; H01F 1/057; C22C 38/00

(52) U.S. Cl. CPC H01F 41/0293; H01F 1/0577; H01F 41/0266; C22C 38/005; C22C 38/002; C22C 2202/02

(57) ABSTRACT

The present disclosure provides an NdFeB rare earth magnet and manufacturing method thereof, which belongs to the field of rare earth magnet technology. The production method of diffusion source is to coat a layer of non-heavy rare earth alloy film on the diffusion source sheet, and aging treatment are carried out to form diffusion source. The diffusion source is R_{α}RH_{δ}M_{β}B_{γ}Fe_{100-α-β-γ-δ}. The chemical formula of the non-heavy rare earth alloy film is RₙMₘ. The chemical formula of NdFeB magnet base material is RₐM¹_{b}M²_{c}B_{d}Fe_{100-a-b-c-d}. The performance NdFeB by diffusion source containing Dy have ΔHcj>636.8 kA/m and containing Tb have ΔHcj>875.6 kA/m, containing DyTb have ΔHcj>716.4 kA/m.

### TECHNICAL FIELD

The disclosure relates to the technical field of NdFeB rare earth magnet, in particular to a rare earth magnet that can improve its own coercivity and its manufacturing method thereof.

### BACKGROUND

NdFeB sintered permanent magnets are widely used in electronic equipment, medical equipment, electric vehicles, household products, robots, etc. In the past few decades of development, NdFeB permanent magnets have been rapidly developed, especially diffusion technology can significantly reduce the consumption of heavy rare earths and has a large cost advantage. Adding heavy rare earth elements Dy or Tb to the NdFeB base material is often used in a manufacturing process of a sintered NdFeB permanent magnet, which will make the heavy rare earth elements Dy and Tb into the grain in large quantities and consume a large number of heavy rare earth elements. This way leads to reduction of the residual magnetism and magnetic energy product of the magnet. Another method is grain boundary diffusion, which is a technology that the diffusion source is diffused into the magnet along the grain boundary to improve the coercivity of the magnet. This technology uses fewer heavy rare earths compared to other technologies, attaining the same coercivity of magnets. So it has attracted a lot of attention because of its low cost. However, with the current price of heavy rare earth Dy, Tb raw materials skyrocketing, the cost of grain boundary diffusion technology using pure Dy and Tb is still high. It is well known that the diffusion technology of heavy rare earth alloys can effectively reduce the content of heavy rare earth Dy and Tb to get low-cost magnets. Therefore, the development of diffusion technology of heavy rare earth alloys is particularly important for the mass production of NdFeB magnets.

CN101641750B discloses the following: The powders containing Rh are coated on the NdFeB sintered magnet. The powders containing Rh are diffused into the NdFeB sintered magnet through the grain boundary, wherein Rh is Dy and/or Tb. The powders contains 0.5-50% of Al by weight, and the oxygen contained in the NdFeB sintered magnet is 0.4 by weight % or less. The patent is mainly to mix different powders to prepare a diffusion source, which are diffused into the magnet to increase coercivity of the magnet. Due to the different density of the powder, the mixed diffusion source will appear a certain degree of aggregation, which will cause uneven magnet performance after diffusion. Although the mixed diffusion source contains heavy rare earths, but the coercivity increased are not bigger than the pure heavy rare hearth after diffusion, and the purpose of cost saving cannot be achieved.

CN106298219B discloses the following: a) the diffusion source is RLᵤRHᵥFe_{100-u-v-w-z}B_{w}M_{z} rare earth alloy, the RL represents at least one element in Pr and Nd, RH represents at least one element in Dy, Tb, Ho, M represents at least one element in Co, Nb, Cu, Al, Ga, Zr, Ti, u, v, w, z is the weight percentage and 0≤u≤10, 35≤v≤70, 0.5≤w≤5, 0≤z≤5. b) Crush RLᵤRHᵥFe_{100-u-v-w-z}B_{w}M_{z} rare earth alloy to form alloy powders. c) The alloy powders are loaded into a rotary diffusion device with an R-T-B magnet for thermal diffusion, with temperature range of 750-950° C. and a time range of 4-72 h. d) Aging treatment. The diffusion source alloy is RLᵤRHᵥFe_{100-u-v-w-z}B_{w}M_{z} rare earth alloys. The following issues exist in this technology: Firstly, when the B content in the diffusion source is too high, its melting point will be relatively high and it is not easy to diffuse into the magnet. Secondly, according to the diffusion source formula, it can be known that the Fe content in the diffusion is ≥10%. When the iron content is too high in the magnet too many ferromagnetic phases are formed, and the performance of the NdFeB magnet is reduced including the Hcj and Br of the magnet.

CN113593800A discloses the following: the diffusion source is RHxM1Bz, the RH is selected from one or two elements in Dy, Tb, M1 is selected from one, two or three elements of Ti, Zr, Al elements, B is boron element, x, y, z represents the weight percentage of the element, x, y, z satisfies the following relationship: 75%≤x≤90%, 0.1%≤z≤0.5%, y=1-x-z. On the one hand, the method improves the Hcj of the sintered NdFeB magnet by diffusion in the detachable material reaction barrel. The method solves the problem of efficiency improvement in the diffusion process, the problem of appearance adhesion. The coercivity is slightly improved, but the long-term use of the diffusion source will inevitably cause certain oxidation and nitridation, but cause further reduction in the utilization rate of heavy rare earths and increase in cost. On the other hand, when the diffusion source contains Ti or Zr, its melting point will be relatively high, resulting in a low diffusion rate. When consuming the same heavy rare earth content, the residual magnetism drops more, the coercivity of the magnet is not further improved. The three-stage temperature rise and fall heat treatment method used is a conventional production process. Based on the above technical analysis, the diffusion source of heavy rare earth alloy encounters the following two problems: on the one hand, the melting point of the diffusion source is too high, resulting in low diffusion rate and the improvement of coercivity is limited; On the other hand, during the diffusion process, the residual magnetism of the magnet with high heavy rare earth content or high Fe content decreases more, resulting in the inability to greatly improve the performance of the magnet.

### SUMMARY

Object of the disclosure: In order to overcome the shortcomings in the prior art, the present disclosure provides NdFeB rare earth magnet and manufacturing method thereof.

Technical solution: In order to achieve the above object, the present disclosure provides an NdFeB rare earth magnet, the NdFeB magnet comprises a main phase, a heavy rare earth shells, a grain boundary phase and a rare earth-rich phase, wherein the grain boundary phase comprises a μ phase and a δ phase, the μ phase is R_{36.5}Fe_{63.5-x}Mₓ, 2.5≤x≤5, and the δ phase is R_{32.5}Fe_{67.5-y}M_{y}, 7≤y≤25, wherein R refers to at least two elements selected from Nd, Pr, Ce and La, and M refers to at least two elements selected from Al, Cu and Ga; the proportions are given in atomic percentages.

A method for preparing NdFeB rare earth magnet described comprising the following steps,
(S1) the preparation of a diffusion source: providing a alloy sheet by smelting, and the chemical formula of the alloy sheet is R_{α}RH_{δ}M_{β}B_{γ}Fe_{100-α-β-γ-δ}, wherein 15≤α≤45, 20≤δ≤70, 10≤δ≤25, 0.2≤γ≤5, R is at least one of Nd and Pr, M is at least one of Al, Cu and Ga, a content Fe is less than 5%, and the proportions are given in mass percentages; coating a layer of non-heavy rare earth alloy film, with a chemical formula of RₙMₘ, on the surface of above alloy sheet, wherein 50≤n≤80, 20≤m≤50, R is at least one of Nd, Pr, Ce and La, and M is at least one of Al, Cu and Ga; taking an aging treatment on the coated alloy sheet to form the diffusion source, then is treated by hydrogen absorption and dehydrogenation;
(S2) the preparation of NdFeB sheet: preparing a NdFeB magnet base material with a chemical formula of RₐM¹_{b}M²_{c}B_{d}Fe_{100-a-b-c-d}, wherein 27≤a≤33, 0.5≤b≤3, 0.5≤c≤2.5, 0.8≤d≤1.2, R refers to one or more elements selected from Dy, Tb, Y, Ho, Gd, Nd, Pr, Ce and La, M¹ refers to one or more elements selected from Al, Cu and Ga, M² refers to one or more elements selected from Ti, Co, Mg, Zn, Nb, Zr, Mo and Sn, the remaining component is Fe, and the proportions are given in mass percentages; making the NdFeB magnet base material into the NdFeB sheet;
(S3) a diffusion source film layer is coated on the NdFeB sheet; and the coated NdFeB sheet is diffused and aged to obtain NdFeB rare earth magnet.

Preferably, in step (S1) and step (S3), the method of coating is a spray coating, dip coating or screen printing coating.

Preferably, in step (S1), the aging treatment temperature is 600-800° C.; the hydrogen absorption temperature of the diffusion source is 50-200° C., and the dehydrogenation temperature is 450-550° C.

Preferably, in step (S1), powder particle size of the diffusion source is 3-60 μm.

Preferably, in step (S2), the NdFeB magnet base material is melted and quick-coagulated to obtain the NdFeB sheet.

Preferably, in step (S2), mixing an NdFeB magnet base material sheet and lubricant, then taking a hydrogen treatment and airflow grinding to obtain mixed powder; the above powder is pressed, formed, and sintered to obtain the NdFeB magnet base material.

Preferably, powder particle size of the airflow grinding is 2-5 μm.

Preferably, the temperature of sintering process for preparing the NdFeB magnet base material is 980-1060° C., sintering time is 6-15 h.

Preferably, in step (S3), diffusion temperature is 850-950° C., diffusion time is 6-30 h, and first-stage aging temperature is 700-850° C., first-level aging time is 2-10 h, second-level aging temperature is 450-600° C., and second-level aging time is 3-10 h.

NdFeB rare earth magnet and manufacturing method thereof of the present disclosure has at least the following technical effects:
(1) The diffusion source alloy R_{α}RH_{δ}M_{β}B_{γ}Fe_{100-α-β-γ-δ} coated with RₙMₘ alloy reducing the proportion of Fe content and increasing the proportion of M, has low content of high melting point B. The diffusion source alloy design can effectively solve the problem of low diffusion rate due to a small amount of B content. This method can well transport heavy rare earths into the magnet, forming heavy rare earth shells, effectively increasing the coercivity of the magnet, and can well improve the diffusion speed.
(2) The diffusion source alloy R_{α}RH_{δ}M_{β}B_{γ}Fe_{100-α-β-γ-δ} contains B element, which can reduce the oxidation problem in the diffusion process, so as to increase the utilization efficiency of the element in the diffusion process.
(3) The diffusion source alloy R_{α}RH_{δ}M_{β}B_{γ}Fe_{100-α-β-γ-δ} contains B element and Fe element, which can form main phase by diffusing into the magnet, and increasing the value Br. Increasing the value Br of the magnet can offset the large decrease in the value of Br during the heavy earth diffusion process, and the residual magnetic decline is less than 0.015 T. The element of Fe can form μ and δ phase with Al, Ga and Cu elements under the process of diffusion, so as to improve the coercivity of the magnet. The decrease of Br is ≤0.15 Kgs, the increase of coercivity Hcj is ≤8 kOe, and the typical increase can reach 9 kOe after diffusing the alloy R_{α}RH_{δ}M_{β}B_{γ}Fe_{100-α-β-γ-δ}.
(4) The diffusion source alloy R_{α}RH_{δ}M_{β}B_{γ}Fe_{100-α-β-γ-δ} coated with RₙMₘ alloy contains B element and Fe element, and the total weight ratio of B and Fe can reach up to 10%, which can greatly reduce the price of diffusion source, thereby reducing production costs.
(5) The diffusion source can be prepared in large quantities, and the coating method can achieve nearly 100% utilization efficiency which can reduce production costs and improve the core competitiveness of NdFeB magnet products in the production process.
(6) The prepared NdFeB magnet base alloy is only sintered to form a sintered state, without the need for primary aging and secondary aging. It can reduce production costs very well. Compared with the prior art, the present disclosure realizes the cooperation between the diffusion source of heavy rare earth alloy and the corresponding component magnet, greatly improves the coercivity of the magnet, and reduces the problem of large Br decline.

### DETAILED DESCRIPTION

The principles and features are described in the present disclosure, and the examples given are only used to explain the present disclosure and are not intended to limit the scope of the present disclosure.

General Concept

There is provided a method of preparing NdFeB rare earth magnet, including the following steps:
(S1) Diffusion source production: diffusion source alloy composition is made up, as shown in Table 1: put into a vacuum melting furnace for melting, pouring to form an alloy sheet, the average thickness of the alloy sheet is 0.25 mm, the content of C and O elements in the alloy sheet is ≤200 ppm, and the N content is ≤50 ppm. The surface of the above-mentioned alloy sheet is coated with a layer of non-heavy rare earth alloy film by using the spraying coating. The sheet is put into the drying furnace for drying at the temperature of 80-150° C., and the weight of the coating layer is less than or equal to 3%. According to table 1, the temperature of aging treatment is 600-800° C., and the degreasing operation is carried out at 250-300° C. during the aging process. The cooling temperature of the diffusion source is lower than 40° C. during the aging cooling process, the cooling method is rapid cooling of circulating airflow, and the cooling gas atmosphere is inert gas such as argon or helium. The diffusion source is under hydrogen absorption and dehydrogenation treatment. The powder particle size is 3-60 μm. The hydrogen absorption temperature is 50-200° C., and the dehydrogenation temperature is 450-550° C. It is worth noting that the alloy sheet having a gap between each other is to prevent the local temperature from being too high during hydrogen absorption and causing sticky flakes and being difficult to take out.
(S2) Ratio of NdFeB base alloy composition, as shown in Table 2, which is put into vacuum melting furnace for melting, pouring to form a thin sheet, cooled at 50° C. and discharged, the average thickness of the sheet is 0.25 mm, The C, O content is ≤200 ppm, the N content 50 ppm. The NdFeB base alloy flakes and lubricants are mixed for hydrogen treatment and then grinded to powders with size of 2-5 μm by argon gas. The NdFeB powder is put into an automatic press, pressed into blanks under a magnetic field, and packaged into blocks. The rough steak is put into the sintering furnace to get NdFeB base alloy, the sintering temperature is 980-1060° C., and the sintering time is 6-15 h. Finally, NdFeB base alloy is cut into strips.
(S3) The diffusion source prepared in step (S1) is prepared into slurry, and the diffusion source slurry is coated with a film on the NdFeB base alloy, and then diffusion and aging treatment are carried out to obtain the NdFeB magnet. Diffusion and aging treatment are carried out to obtain NdFeB magnet, specific process conditions and the performance of NdFeB magnet is shown in Table 3.

In order to verify the present scheme, eighteen pairs of examples and comparative examples are designed and the difference between the comparative examples and the examples is as follows: The diffusion source of the comparative examples have no the components of B or Fe. The composition and process conditions of the comparative examples are shown in Table 4. The diffusion source is put into vacuum melting furnace for melting, pouring to form a thin sheet, cooled at 50° C. and discharged, the average thickness of the sheet is 0.25 mm, The content of C or O is ≤200 ppm, the N content 50 ppm.

Based on the above data, the NdFeB earth magnet is obtained by diffusion source alloy R_{α}RH_{δ}M_{β}B_{γ}Fe_{100-α-β-γ-δ}. All examples in which the performance NdFeB by diffusion source containing Dy have ΔHcj of more than 636.8 kA/m and containing Tb have ΔHcj of more than 875.6 kA/m, containing DyTb have ΔHcj of more than 716.4 kA/m. The residual magnetic reduction of the embodiment was significantly lower than the proportion, and the coercivity of the embodiment was higher than the comparative example therefore, the examples and comparative examples are specifically analyzed as follows:
Example 1 and Comparative example 1: The NdFeB magnet base alloy are diffused at the same composition and size, the same diffusion and aging temperature etc. Example 1 shows Br=1.330 T, Hcj=2069.6 kA/m, containing μ phase and δ phase and Comparative example 1 shows Br=1.315 T, Hcj=1990 kA/m, only containing δ phase. The Br (residual magnetism) and Hcj (coercivity) advantages of the Example are higher than the Comparative example significantly.
Example 2 and Comparative example 2: The NdFeB magnet base alloy are diffused at the same composition and size, the same diffusion and aging temperature etc. Example 2 shows Br=1.275 T, Hcj=1830.8 kA/m, containing μ phase and δ phase and Comparative example 2 shows Br-1.260 T, Hcj-1791 kA/m, only containing δ phase. The Br (residual magnetism) and Hcj (coercivity) advantages of the Example are higher than the Comparative example significantly.
Example 3 and Comparative example 3: The NdFeB magnet base alloy are diffused at the same composition and size, the same diffusion and aging temperature etc. Example 3 shows Br=1.475 T, Hcj=1950.2 kA/m, containing μ phase and δ phase and Comparative example 3 shows Br-1.460 T, Hcj-1830.8 kA/m, only containing δ phase. The Br (residual magnetism) and Hcj (coercivity) advantages of the Example are higher than the Comparative example significantly.
Example 4 and Comparative example 4: The NdFeB magnet base alloy are diffused at the same composition and size, the same diffusion and aging temperature etc. Example 4 shows Br=1.465 T, Hcj-1830.80 kA/m, containing μ phase and δ phase and Comparative example 4 shows Br=1.450 T, Hcj=1751.2 kA/m. The Br (residual magnetism) and Hcj (coercivity) advantages of the Example are higher than the Comparative example significantly.
Example 5 and Comparative example 5: The NdFeB magnet base alloy are diffused at the same composition and size, the same diffusion and aging temperature etc. Example 5 shows Br=1.450 T, Hcj=1870.6 kA/m, containing μ phase and δ phase and Comparative example 5 shows Br-1.430 T, Hcj-1751.2 kA/m. The Br (residual magnetism) and Hcj (coercivity) advantages of the Example are higher than the Comparative example significantly.
Example 6 and Comparative example 6: The NdFeB magnet base alloy are diffused at the same composition and size, the same diffusion and aging temperature etc. Example 6 shows Br-1.435 T, Hcj-1990 kA/m, containing μ phase and δ phase and Comparative example 6 shows Br=1.420 T, Hcj=1950.2 kA/m. The Br (residual magnetism) and Hcj (coercivity) advantages of the Example are higher than the Comparative example significantly.
Example 7 and Comparative example 7: The NdFeB magnet base alloy are diffused at the same composition and size, the same diffusion and aging temperature etc. Example 7 shows Br-1.415 T, Hcj-2069.6 kA/m, containing μ phase and δ phase and Comparative example 7 shows Br=1.390 T, Hcj=1950.20 kA/m. The Br (residual magnetism) and Hcj (coercivity) advantages of the Example are higher than the Comparative example significantly.
Example 8 and Comparative example 8: The NdFeB magnet base alloy are diffused at the same composition and size, the same diffusion and aging temperature etc. Example 8 shows Br=1.390 T, Hcj=2228.80 kA/m, containing μ phase and δ phase and Comparative example 8 shows Br-1.370 T, Hcj-2109.40 kA/m. The Br (residual magnetism) and Hcj (coercivity) advantages of the Example are higher than the Comparative example significantly.
Example 9 and Comparative example 9: The NdFeB magnet base alloy are diffused at the same composition and size, the same diffusion and aging temperature etc. Example 9 shows Br=1.400 T, Hcj-2109.40 kA/m, containing μ phase and δ phase and Comparative example 9 shows Br=1.380 T, Hcj=1974.08 kA/m. The Br (residual magnetism) and Hcj (coercivity) advantages of the Example are higher than the Comparative example significantly.
Example 10 and Comparative example 10: The NdFeB magnet base alloy are diffused at the same composition and size, the same diffusion and aging temperature etc. Example 10 shows Br=1.345 T, Hcj=2109.40 kA/m, containing μ phase and δ phase and Comparative example 10 shows Br-1.330 T, Hcj-1950.20 kA/m, only containing δ phase. The Br (residual magnetism) and Hcj (coercivity) advantages of the Example are higher than the Comparative example significantly.
Example 11 and Comparative example 11: The NdFeB magnet base alloy are diffused at the same composition and size, the same diffusion and aging temperature etc. Example 11 shows Br=1.335 T, Hcj=2149.2 kA/m, containing μ phase and δ phase and Comparative example 11 shows Br-1.320 T, Hcj-1990 kA/m, only containing δ phase. The Br (residual magnetism) and Hcj (coercivity) advantages of the Example are higher than the Comparative example significantly.
Example 12 and Comparative example 12: The NdFeB magnet base alloy are diffused at the same composition and size, the same diffusion and aging temperature etc. Example 12 shows Br-1.385 T, Hcj-2029.80 kA/m, containing μ phase and δ phase and Comparative example 12 shows Br=1.365 T, Hcj=1870.60 kA/m. The Br (residual magnetism) and Hcj (coercivity) advantages of the Example are higher than the Comparative example significantly.
Example 13 and Comparative example 13: The NdFeB magnet base alloy are diffused at the same composition and size, the same diffusion and aging temperature etc. Example 13 shows Br=1.385 T, Hcj=2467.60 kA/m, containing μ phase and δ phase and Comparative example 13 shows Br-1.370 T, Hcj-2268.60 kA/m. The Br (residual magnetism) and Hcj (coercivity) advantages of the Example are higher than the Comparative example significantly.
Example 14 and Comparative example 14: The NdFeB magnet base alloy are diffused at the same composition and size, the same diffusion and aging temperature etc. Example 14 shows Br-1.375 T, Hcj-2228.80 kA/m, containing μ phase and δ phase and Comparative example 14 shows Br=1.360 T, Hcj=2109.40 kA/m. The Br (residual magnetism) and Hcj (coercivity) advantages of the Example are higher than the Comparative example significantly.
Example 15 and Comparative example 15: The NdFeB magnet base alloy are diffused at the same composition and size, the same diffusion and aging temperature etc. Example 15 shows Br=1.335 T, Hcj=2149.2 kA/m, containing μ phase and δ phase and Comparative example 15 shows Br-1.325 T, Hcj-1990.00 kA/m. The Br (residual magnetism) and Hcj (coercivity) advantages of the Example are higher than the Comparative example significantly.
Example 16 and Comparative example 16: The NdFeB magnet base alloy are diffused at the same composition and size, the same diffusion and aging temperature etc. Example 16 shows Br=1.340 T, Hcj=2308.4 kA/m, containing μ phase and δ phase and Comparative example 16 shows Br-1.325 T, Hcj-2149.20 kA/m, only containing δ phase. The Br (residual magnetism) and Hcj (coercivity) advantages of the Example are higher than the Comparative example significantly.
Example 17 and Comparative example 17: The NdFeB magnet base alloy are diffused at the same composition and size, the same diffusion and aging temperature etc. Example 17 shows Br-1.260 T, Hcj-2308.4 kA/m, containing μ phase and δ phase and Comparative example 17 shows Br=1.250 T, Hcj=2149.20 kA/m, only containing δ phase. The Br (residual magnetism) and Hcj (coercivity) advantages of the Example are higher than the Comparative example significantly.
Example 18 and Comparative example 18: The NdFeB magnet base alloy are diffused at the same composition and size, the same diffusion and aging temperature etc. Example 18 shows Br=1.360 T, Hcj=2228.80 kA/m, containing μ phase and δ phase and Comparative example 18 shows Br-1.345 T, Hcj-2109.40 kA/m. The Br (residual magnetism) and Hcj (coercivity) advantages of the Example are higher than the Comparative example significantly.

The foregoing is only a better Example of the present disclosure and is not intended to limit the present disclosure, where any modification, equivalent substitution, improvement etc. made within the spirit and principles of the present disclosure shall be included in the scope of protection of the present disclosure.

TABLE 1
Diffusion sources composition

| Number | R_{α}RH_{δ}M_{β}B_{γ}Fe_{100-α-β-γ-δ} | RₙMₘ |
|---|---|---|
| Example 1 | Pr: 30%, Tb: 45%, Al: 10%, B: 4%, Fe: Margin | Pr: 82% Ga: 18% |
| Example 2 | Pr: 30%, Tb: 45%, Cu: 15%, B: 3%, Fe: Margin | Pr: 70% Cu: 20% Ga: 10% |
| Example 3 | Nd: 20%, Tb: 45%, Al: 12%, Cu: 13%, B: 3%, Fe: Margin | Pr: 50% Cu: 30% Ga: 20% |
| Example 4 | Pr: 30%, Dy: 45%, Al: 10%, Ga: 5%, B: 5%, Fe: Margin | Nd: 60% Cu: 40% |
| Example 5 | Pr: 30%, Dy: 45%, Ga: 10%, Cu: 5%, B: 5%, Fe: Margin | Nd: 70% Cu: 20% Ga: 10% |
| Example 6 | Nd: 30%, Dy: 45%, Cu: 15%, B: 2%, Fe: Margin | Pr: 80% Al: 20% |
| Example 7 | Pr: 30%, Dy: 50%, Ga: 10%, B: 1%, Fe: Margin | Nd: 70% La: 5% Cu: 25% |
| Example 8 | Pr: 20%, Tb: 50%, Ga: 10%, Cu: 10%, B: 3%, Fe: Margin | Pr: 50% Ce: 5% Cu: 45% |
| Example 9 | Pr: 15%, Dy: 70%, Cu: 10%, B: 2%, Fe: Margin | Pr: 75% La: 6% Ga: 19% |
| Example 10 | Pr: 15%, Dy: 70%, Al: 10%, B: 0.5%, Fe: Margin | Pr: 60% Cu: 40% |
| Example 11 | Pr: 15%, Dy: 70%, Al: 5%, Cu: 5%, B: 1%, Fe: Margin | Pr: 65% Ce: 5% Cu: 30% |
| Example 12 | Nd: 25%, Dy: 60%, Cu: 10%, B: 0.5%, Fe: Margin | Pr: 75% Ga: 25% |
| Example 13 | Nd: 25%, Tb: 60%, Cu: 10%, B: 2%, Fe: Margin | Pr: 50% La: 5% Cu: 45% |
| Example 14 | Nd: 45%, Tb: 30%, Cu: 10%, Al: 10%, B: 2%, Fe: Margin | Pr: 75% La: 6% Ga: 19% |
| Example 15 | Nd: 30%, Dy: 50%, Cu: 10%, Ga: 3%, B: 4%, Fe: Margin | Nd: 70% Cu: 30% |
| Example 16 | Pr: 20%, Dy: 40%, Tb: 10%, Cu: 10%, Al: 5%, B: 5%, Fe: Margin | Nd: 65% Ce: 5% Cu: 30% |
| Example 17 | Pr: 20%, Tb: 40%, Dy: 10%, Cu: 10%, Al: 5%, B: 4%, Fe: Margin | Nd: 50% Ga: 10% Cu: 40% |
| Example 18 | Pr: 30%, Dy: 40%, Tb: 10%, Cu: 10%, B: 2%, Fe: Margin | Nd: 50% Ga: 25% Cu: 25% |

TABLE 2
Composition of NdFeB base alloy and its performance

| | Composition of NdFeB base alloy | | | | | | | | | | | | | | | | | |
|---|---|---|---|---|---|---|---|---|---|---|---|---|---|---|---|---|---|---|
| | R | | | | | | | M1 | | | M2 | | | | | Performance | | |
| Number | Pr | Nd | Ce | Ho | Gd | Dy | Tb | Cu | Al | Ga | Co | Ti | Zr | Fe | B | Br(T) | Hcj(kA/m) | Hk/Hcj |
| 1 | 6.19 | 24.75 | 2.00 | 0.00 | 0.00 | 0.00 | 0.00 | 0.29 | 0.40 | 0.10 | 1.00 | 0.05 | 0.00 | Margin | 0.92 | 1.340 | 1162.16 | 0.98 |
| 2 | 0.00 | 23.52 | 8.00 | 0.00 | 0.00 | 0.00 | 0.00 | 0.44 | 0.53 | 0.21 | 1.00 | 0.20 | 0.05 | Margin | 0.94 | 1.280 | 915.40 | 0.98 |
| 3 | 0.00 | 29.50 | 0.00 | 0.00 | 0.00 | 0.00 | 0.00 | 0.15 | 0.05 | 0.10 | 0.90 | 0.00 | 0.10 | Margin | 0.92 | 1.485 | 955.20 | 0.98 |
| 4 | 7.70 | 21.92 | 0.00 | 0.00 | 0.00 | 0.00 | 0.00 | 0.16 | 0.06 | 0.09 | 1.50 | 0.00 | 0.08 | Margin | 0.91 | 1.473 | 1106.44 | 0.98 |
| 5 | 0.00 | 29.20 | 0.00 | 0.00 | 0.00 | 0.00 | 0.30 | 0.15 | 0.05 | 0.20 | 1.00 | 0.10 | 0.00 | Margin | 0.94 | 1.460 | 1194.00 | 0.98 |
| 6 | 7.51 | 22.27 | 0.00 | 0.00 | 0.00 | 0.00 | 0.00 | 0.21 | 0.11 | 0.20 | 1.94 | 0.01 | 0.00 | Margin | 0.90 | 1.440 | 1305.44 | 0.98 |
| 7 | 6.46 | 23.70 | 0.00 | 0.00 | 0.00 | 0.00 | 0.00 | 0.15 | 0.20 | 0.20 | 1.31 | 0.14 | 0.00 | Margin | 0.95 | 1.427 | 1273.60 | 0.98 |
| 8 | 7.50 | 23.20 | 0.00 | 0.00 | 0.00 | 0.00 | 0.00 | 0.16 | 0.23 | 0.21 | 0.91 | 0.15 | 0.00 | Margin | 0.95 | 1.398 | 1313.40 | 0.99 |
| 9 | 6.26 | 25.04 | 0.00 | 0.00 | 0.00 | 0.00 | 0.00 | 0.15 | 0.20 | 0.20 | 1.50 | 0.10 | 0.00 | Margin | 0.94 | 1.410 | 1278.38 | 0.98 |
| 10 | 7.70 | 23.70 | 0.00 | 0.00 | 0.00 | 0.00 | 0.00 | 0.15 | 0.60 | 0.22 | 1.00 | 0.10 | 0.05 | Margin | 0.90 | 1.360 | 1393.00 | 0.99 |
| 11 | 6.24 | 24.96 | 0.00 | 0.00 | 0.00 | 0.00 | 0.00 | 0.30 | 0.80 | 0.20 | 1.00 | 0.10 | 0.00 | Margin | 0.98 | 1.346 | 1416.88 | 0.99 |
| 12 | 0.13 | 31.44 | 0.00 | 0.00 | 0.00 | 0.00 | 0.00 | 0.20 | 0.27 | 0.24 | 1.00 | 0.15 | 0.00 | Margin | 0.94 | 1.390 | 1273.60 | 0.98 |
| 13 | 5.98 | 23.92 | 0.00 | 0.00 | 0.00 | 0.00 | 1.10 | 0.01 | 0.20 | 0.30 | 1.00 | 0.05 | 0.04 | Margin | 0.91 | 1.395 | 1552.20 | 0.98 |
| 14 | 0.24 | 31.23 | 0.00 | 0.00 | 0.00 | 0.00 | 0.00 | 0.18 | 0.43 | 0.23 | 1.97 | 0.18 | 0.00 | Margin | 0.97 | 1.375 | 1353.20 | 0.98 |
| 15 | 5.90 | 24.18 | 0.00 | 1.00 | 0.00 | 0.00 | 0.00 | 0.18 | 0.30 | 0.18 | 0.50 | 0.18 | 0.00 | Margin | 0.93 | 1.340 | 1476.58 | 0.99 |
| 16 | 5.60 | 23.21 | 0.00 | 0.88 | 0.00 | 0.86 | 0.00 | 0.20 | 0.37 | 0.25 | 1.00 | 0.14 | 0.00 | Margin | 0.95 | 1.350 | 1512.40 | 0.98 |
| 17 | 6.06 | 23.17 | 0.00 | 0.00 | 2.60 | 0.00 | 0.00 | 0.16 | 0.95 | 0.31 | 1.53 | 0.10 | 0.00 | Margin | 0.94 | 1.266 | 1521.95 | 0.99 |
| 18 | 5.43 | 23.00 | 0.00 | 1.35 | 0.00 | 0.55 | 0.00 | 0.20 | 0.30 | 0.25 | 1.00 | 0.15 | 0.00 | Margin | 0.94 | 1.370 | 1432.80 | 0.98 |

TABLE 3
Conditions and characteristics of the NdFeB magnet base alloy after diffusion about embodiment.

| | | | | first- | | second- | | | | | | |
|---|---|---|---|---|---|---|---|---|---|---|---|---|
| | | | | level | | level | | Performance | | | | |
| | | Diffusion | holding | aging | holding | aging | holding | after Diffusion | | | Whether | Whether |
| Example | Size | Temp. | time | Temp. | time | Temp. | time | Br | Hcj | | contains | contains |
| No. | mm | ° C. | h | ° C. | h | ° C. | h | T | kA/m | Hk/Hcj | μ phase | δ phase |
| 1 | 10*10*3 | 850 | 30 | 700 | 2 | 510 | 10 | 1.33 | 2069.6 | 0.97 | Yes | Yes |
| 2 | 10*10*4 | 900 | 15 | 700 | 3 | 480 | 7 | 1.275 | 1830.8 | 0.96 | Yes | Yes |
| 3 | 10*10*3 | 850 | 30 | 700 | 5 | 500 | 5 | 1.475 | 1950.2 | 0.96 | Yes | Yes |
| 4 | 10*10*3 | 900 | 10 | 700 | 8 | 530 | 8 | 1.465 | 1830.8 | 0.97 | Yes | Yes |
| 5 | 10*10*4 | 900 | 20 | 750 | 10 | 540 | 6 | 1.45 | 1870.6 | 0.97 | Yes | Yes |
| 6 | 10*10*4 | 910 | 20 | 750 | 2 | 600 | 5 | 1.435 | 1990 | 0.96 | Yes | Yes |
| 7 | 10*10*4 | 920 | 20 | 750 | 3 | 500 | 3 | 1.415 | 2069.6 | 0.97 | Yes | Yes |
| 8 | 10*10*4 | 910 | 15 | 750 | 5 | 460 | 6 | 1.39 | 2228.8 | 0.97 | Yes | Yes |
| 9 | 10*10*5 | 930 | 16 | 800 | 8 | 450 | 8 | 1.4 | 2109.4 | 0.96 | Yes | Yes |
| 10 | 10*10*5 | 940 | 10 | 800 | 10 | 520 | 6 | 1.345 | 2109.4 | 0.97 | Yes | Yes |
| 11 | 10*10*5 | 930 | 20 | 800 | 2 | 600 | 5 | 1.335 | 2149.2 | 0.97 | Yes | Yes |
| 12 | 10*10*6 | 950 | 20 | 800 | 3 | 500 | 8 | 1.385 | 2029.8 | 0.97 | Yes | Yes |
| 13 | 10*10*4 | 910 | 15 | 800 | 5 | 450 | 8 | 1.385 | 2467.6 | 0.97 | Yes | Yes |
| 14 | 10*10*3 | 850 | 10 | 850 | 8 | 500 | 6 | 1.375 | 2228.8 | 0.96 | Yes | Yes |
| 15 | 10*10*8 | 950 | 30 | 850 | 10 | 520 | 10 | 1.335 | 2149.2 | 0.96 | Yes | Yes |
| 16 | 10*10*3 | 910 | 10 | 850 | 3 | 500 | 5 | 1.34 | 2308.4 | 0.97 | Yes | Yes |
| 17 | 10*10*3 | 930 | 6 | 850 | 5 | 600 | 3 | 1.26 | 2308.4 | 0.96 | Yes | Yes |
| 18 | 10*10*5 | 940 | 8 | 850 | 8 | 580 | 8 | 1.36 | 2228.8 | 0.97 | Yes | Yes |

TABLE 4
Diffusion sources, process conditions and characteristics of the NdFeB magnet base alloy after diffusion about proportion.

| Compar- | | | | | | | | | | | |
|---|---|---|---|---|---|---|---|---|---|---|---|
| ative | | | Diffusion | Holding | Aging | Holding | Performance | | | Whether | Whether |
| Example | | Size | Temp. | time | Temp. | time | after Diffusion | | | contains | contains |
| No. | Diffussion source | mm | ° C. | h | ° C. | h | Br | Hcj | Hk/Hcj | μ phase | δ phase |
| 1 | Pr: 45%, Tb: 45%, | 10*10*3 | 850 | 30 | 510 | 10 | 1.315 | 1990.00 | 0.97 | NO | Yes |
| | Al: 10% | | | | | | | | | | |
| 2 | Pr: 40%, Tb: 45%, | 10*10*4 | 900 | 15 | 480 | 7 | 1.260 | 1791.00 | 0.96 | NO | Yes |
| | Cu: 15% | | | | | | | | | | |
| 3 | Nd: 30%, Tb: 45%, | 10*10*3 | 850 | 30 | 500 | 5 | 1.460 | 1830.80 | 0.96 | NO | NO |
| | Al: 12%, Cu: 13%, | | | | | | | | | | |
| 4 | Pr: 40%, Dy: 45%, | 10*10*3 | 900 | 10 | 530 | 8 | 1.450 | 1751.20 | 0.97 | NO | NO |
| | Al: 10%, Ga: 5% | | | | | | | | | | |
| 5 | Pr: 40%, Dy: 45%, | 10*10*4 | 900 | 20 | 540 | 6 | 1.430 | 1751.20 | 0.97 | NO | NO |
| | Ga: 10%, Cu: 5% | | | | | | | | | | |
| 6 | Nd: 40%, Dy: 45%, | 10*10*4 | 910 | 20 | 600 | 5 | 1.420 | 1950.20 | 0.96 | NO | NO |
| | Cu: 15% | | | | | | | | | | |
| 7 | Pr: 40%, Dy: 50%, | 10*10*4 | 920 | 20 | 500 | 3 | 1.390 | 1950.20 | 0.97 | NO | NO |
| | Ga: 10% | | | | | | | | | | |
| 8 | Pr: 30%, Tb: 50%, | 10*10*4 | 910 | 15 | 460 | 6 | 1.370 | 2109.40 | 0.96 | NO | NO |
| | Ga: 10%, Cu: 10% | | | | | | | | | | |
| 9 | Pr: 20%, Dy: 70%, | 10*10*5 | 930 | 16 | 450 | 8 | 1.380 | 1974.08 | 0.96 | NO | NO |
| | Cu: 10% | | | | | | | | | | |
| 10 | Pr: 20%, Dy: 70%, | 10*10*5 | 940 | 10 | 520 | 6 | 1.330 | 1950.20 | 0.97 | NO | Yes |
| | Al: 10% | | | | | | | | | | |
| 11 | Pr: 20%, Dy: 70%, | 10*10*5 | 930 | 20 | 600 | 5 | 1.320 | 1990.00 | 0.97 | NO | Yes |
| | Al: 5%, Cu: 5% | | | | | | | | | | |
| 12 | Nd: 30%, Dy: 60%, | 10*10*6 | 950 | 20 | 500 | 8 | 1.365 | 1870.60 | 0.97 | NO | NO |
| | Cu: 10% | | | | | | | | | | |
| 13 | Nd: 30%, Tb: 60%, | 10*10*4 | 910 | 15 | 450 | 8 | 1.370 | 2268.60 | 0.96 | NO | Yes |
| | Cu: 10% | | | | | | | | | | |
| 14 | Nd: 50%, Tb: 30%, | 10*10*3 | 850 | 10 | 500 | 6 | 1.360 | 2109.40 | 0.97 | NO | NO |
| | Cu: 10%, Al: 10% | | | | | | | | | | |
| 15 | Nd: 37%, Dy: 50%, | 10*10*8 | 950 | 30 | 520 | 10 | 1.325 | 1990.00 | 0.97 | NO | NO |
| | Cu: 10%, Ga: 3% | | | | | | | | | | |
| 16 | Pr: 35%, Dy: 40%, | 10*10*3 | 910 | 10 | 500 | 5 | 1.325 | 2149.20 | 0.97 | NO | Yes |
| | Tb: 10%, Cu: 10%, | | | | | | | | | | |
| | Al: 5% | | | | | | | | | | |
| 17 | Pr: 35%, Tb: 40%, | 10*10*3 | 930 | 6 | 600 | 3 | 1.250 | 2149.20 | 0.96 | NO | Yes |
| | Dy: 10%, Cu: 10%, | | | | | | | | | | |
| | Al: 5% | | | | | | | | | | |
| 18 | Pr: 40%, Dy: 40%, | 10*10*5 | 940 | 8 | 580 | 8 | 1.345 | 2109.40 | 0.97 | NO | NO |
| | Tb: 10%, Cu: 10% | | | | | | | | | | |

What claimed is:

1. An NdFeB rare earth magnet, wherein the NdFeB magnet comprises a main phase, a heavy rare earth shells, a grain boundary phase and a rare earth-rich phase, wherein the grain boundary phase comprises a μ phase and a δ phase, the μ phase is R_{36.5}Fe_{63.5-x}Mₓ, 2.5≤x≤5, and the δ phase is R_{32.5}Fe_{67.5-y}M_{y}, 7≤y≤25, wherein R refers to at least two elements selected from Nd, Pr, Ce and La, and M refers to at least two elements selected from Al, Cu and Ga; the proportions are given in atomic percentages.

2. A method for preparing the NdFeB rare earth magnet according to claim 1 comprising the following steps,
(S1) the preparation of a diffusion source: providing a alloy sheet by smelting, and the chemical formula of the alloy sheet is R_{α}RH_{δ}M_{β}B_{γ}Fe_{100-α-β-γ-δ}, wherein 15≤α≤45, 20≤δ≤70, 10≤β≤25, 0.2≤γ≤5, R is at least one of Nd and Pr, M is at least one of Al, Cu and Ga, a content Fe is less than 5%, and the proportions are given in mass percentages; coating a layer of non-heavy rare earth alloy film, with a chemical formula of RₙMₘ, on the surface of above alloy sheet, wherein 50≤n≤80, 20≤m≤50, R is at least one of Nd, Pr, Ce and La, and M is at least one of Al, Cu and Ga; taking an aging treatment on the coated alloy sheet to form the diffusion source, then is treated by hydrogen absorption and dehydrogenation;
(S2) the preparation of NdFeB sheet: preparing a NdFeB magnet base material with a chemical formula of RₐM¹_{b}M²_{c}B_{d}Fe_{100-a-b-c-d}, wherein 27≤a≤33, 0.5≤b≤3, 0.5≤c≤2.5, 0.8≤d≤1.2, R refers to one or more elements selected from Dy, Tb, Y, Ho, Gd, Nd, Pr, Ce and La, M¹ refers to one or more elements selected from Al, Cu and Ga, M² refers to one or more elements selected from Ti, Co, Mg, Zn, Nb, Zr, Mo and Sn, the remaining component is Fe, and the proportions are given in mass percentages; making the NdFeB magnet base material into the NdFeB sheet;
(S3) a diffusion source film layer is coated on the NdFeB sheet; and the coated NdFeB sheet is diffused and aged to obtain NdFeB rare earth magnet.

3. The method preparing the NdFeB rare earth magnet according to claim 2, wherein in step (S1) and step (S3), the method of coating is a spray coating, dip coating or screen printing coating.

4. The method preparing the NdFeB rare earth magnet according to claim 2, wherein in step (S1), the aging treatment temperature is 600-800° C.; the hydrogen absorption temperature of the diffusion source is 50-200° C., and the dehydrogenation temperature is 450-550° C.

5. The method preparing the NdFeB rare earth magnet according to claim 2, wherein in step (S1), powder particle size of the diffusion source is 3-60 μm.

6. The method preparing the NdFeB rare earth magnet according to claim 2, wherein in step (S2), the NdFeB magnet base material is melted and quick-coagulated to obtain the NdFeB sheet.

7. The method preparing the NdFeB rare earth magnet according to claim 2, wherein in step (S2), mixing a NdFeB magnet base material sheet and lubricant, then taking a hydrogen treatment and airflow grinding to obtain mixed powder; the above powder is pressed, formed, and sintered to obtain the NdFeB magnet base material.

8. The method preparing the NdFeB rare earth magnet according to claim 7, wherein powder particle size of the airflow grinding is 2-5 μm.

9. The method preparing the NdFeB rare earth magnet according to claim 7, wherein the temperature of sintering process for preparing the NdFeB magnet base material is 980-1060° C., sintering time is 6-15 h.

10. The method preparing the NdFeB rare earth magnet according to claim 2, wherein in step (S3), diffusion temperature is 850-950° C., diffusion time is 6-30 h, and first-stage aging temperature is 700-850° C., first-level aging time is 2-10 h, second-level aging temperature is 450-600° C., and second-level aging time is 3-10 h.

11. An NdFeB rare earth magnet prepared by the method according to claim 2.

12. The NdFeB rare earth magnet according to claim 11, wherein the NdFeB magnet comprises a main phase, a heavy rare earth shells, a grain boundary phase and a rare earth-rich phase, wherein the grain boundary phase comprises a μ phase and a δ phase, the μ phase is R_{36.6}Fe_{63.5-x}Mₓ, 2.5≤x≤5, and the δ phase is R_{32.5}Fe_{67.5-y}M_{y}, 7≤y≤25, wherein R refers to at least two elements selected from Nd, Pr, Ce and La, and M refers to at least two elements selected from Al, Cu and Ga; the proportions are given in atomic percentages.
